(19) United States
(12) Patent Application Publication
(10) Pub. No.: US 2002/0059796 A1
(43) Pub. Date: May 23, 2002

(54) Master cylinder arrangement

(76) Inventor: Werner Dieringer, Vallendar (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/044,741

(22) Filed: Jan. 11, 2002

Related U.S. Application Data
(63) Continuation of application No. PCT/EP00/06032, filed on Jun. 28, 2000.

(30) Foreign Application Priority Data
Jul. 13, 1999 (DE) 199 32 670.3

(51) Int. Cl. B60T 17/00

(52) U.S. Cl. 60/565

(57) ABSTRACT

A master cylinder arrangement (10) for a vehicle hydraulic brake system has a housing (14) and a bore (16), which is formed in said housing along an axis (A) and in which at least one filling chamber (18) and a first pressure chamber (22) are delimited. A filling piston (38) and a first pressure piston (40) connected thereto displace fluid from the filling chamber (18) to the suction side of a hydraulic pump (60), the discharge end of which delivers pumped fluid into a first brake circuit (64), and from the first pressure chamber (22) into the first brake circuit (64). To realize a desired, so-called “entry behaviour”, the filling piston (38) and the first pressure piston (40) are movable relative to one another by a limited amount (s) along the axis (A). Furthermore, the filling piston (38) and the first pressure piston (40) are spring-biased in relation to one another in such a way that they are pushed apart from one another, and the filling piston (38) couples rigidly to the first pressure piston (40) after both pistons (38, 40) have been moved relative to one another by the amount (s) counter to the spring force pushing them apart from one another.

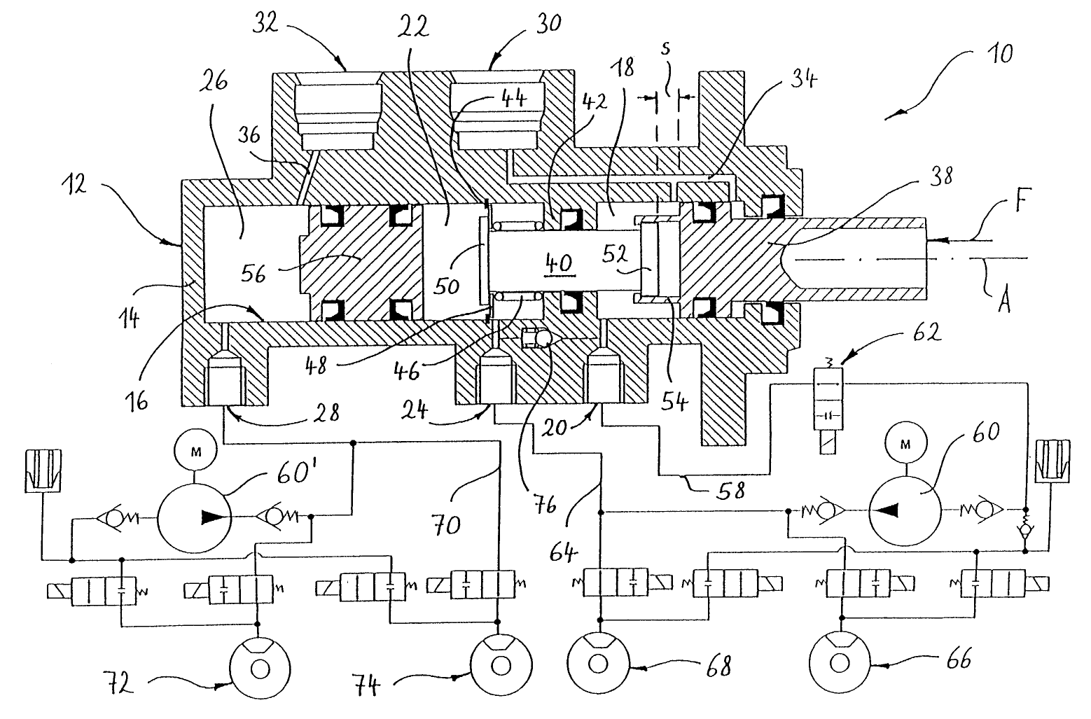

The invention relates to a master cylinder arrangement for a vehicle hydraulic brake system according to the preamble of claim 1.

Such a master cylinder arrangement is known from DE 196 20 228 A1. The master cylinder described there is intended for use with an upstream brake booster which is actuable independently of the driver in order to enable operation of the brake system also without the foot force of the driver. Only in such a way is it possible to realize functions such as, for example, traction control or vehicle dynamics control, in which individual vehicle wheels have to be braked without brake actuation by the driver. In order to make a sufficiently high braking force available for such functions, the pressure boost of the master cylinder described in DE 196 20 228 A1 can be changed over. To avoid lengthening of the pedal travel, which occurs in the position of the greater pressure boost because of the smaller hydraulically effective area, a hydraulic pump pumps brake fluid from a filling chamber into a first brake circuit associated with a first pressure chamber. The master cylinder arrangement according to DE 196 20 228 A1 is neither intended nor suitable for use without an upstream brake booster.

The object of the invention is to provide a simply constructed master cylinder arrangement for a vehicle hydraulic brake system, which may be operated without an upstream brake booster and which performs in a manner corresponding to the performance of conventional brake booster/master cylinder units.

Proceeding from a master cylinder arrangement of the type described initially, said object is achieved according to the invention in that the filling piston and the first pressure piston are movable relative to one another by a limited amount along their common principal axis, wherein the filling piston and the first pressure piston are spring-biased in relation to one another in such a way that they are pushed apart from one another, and wherein the filling piston and the first pressure piston couple rigidly to one another after they have been moved towards one another by the said amount counter to the spring force pushing them apart from one another.

The effect thereby achieved is that the actuating force in the initial phase of a braking operation is low, because at first only the filling piston is displaced relative to the first pressure piston and displaces fluid from the filling chamber to the hydraulic pump, which then supplies said fluid to the first brake circuit and therefore increases the pressure there in accordance with the quantity of fluid delivered from the filling chamber into the first brake circuit. This means that in the initial phase of a braking operation the actuating force introduced by a driver is boosted to a relatively high degree, which conveys to the driver the feeling of possessing an efficiently operating, adequately dimensioned brake system. Said performance of the master cylinder arrangement according to the invention corresponds to the performance of conventional (vacuum) brake booster/master cylinder units, in which a so-called reaction disk of springy elastic material, which is disposed between the brake booster and the master cylinder, in cooperation with a so-called sensing disk ensures that the introduced actuating force is boosted to a much greater extent at the beginning of an actuation than at a later stage of a braking operation.

The relative movement between the filling piston and the first pressure piston occurs because from the filling chamber fluid is merely displaced, i.e. the filling chamber remains unpressurized, whereas in the first pressure chamber, which is connected in a fluid-conveying manner to the first brake circuit, the pressure arises, which the hydraulic pump generates in the first brake circuit by pumping the fluid, which is displaced from the filling chamber by the movement of the filling piston, into the first brake circuit. The first pressure piston accordingly remains stationary relative to the filling piston during the initial phase of an actuation or—as pressure rises in the first brake circuit—even moves counter to actuating direction towards the filling piston. It is only when in the course of said relative movement the said limited amount has been overcome that the first pressure piston couples rigidly to the filling piston, so that said two pistons upon a further displacement in actuating direction behave like a single piston. From said moment on, the pressure in the first pressure chamber also retroacts via the first pressure piston upon the filling piston and is therefore communicated to the driver. A further brake pressure increase now requires a greater actuating force from the driver because he has to displace the first pressure piston counter to the pressure in the first pressure chamber. At the same time, however, upon a further displacement in actuating direction of the first pressure piston and of the filling piston coupled thereto further fluid is also displaced from the filling chamber to the hydraulic pump, which supplies said fluid under increased pressure to the first brake circuit. The actuating force introduced by the driver is accordingly still boosted, albeit no longer by as high a factor as at the start of an actuation.

In a preferred embodiment of a master cylinder arrangement according to the invention, a stop defines an inoperative position of the first pressure piston, from which position it is displaceable both in actuating direction and counter to actuating direction. A spring acting in actuating direction pushes the first pressure piston in the direction of the said stop as soon as the first pressure piston is displaced from its inoperative position counter to actuating direction. The stop is preferably designed in such a way that it takes up the force of the said spring in the inoperative position of the first pressure piston so that, when the first pressure piston is situated in its inoperative position or in a position displaced in actuating direction, the force of the said spring does not act upon the first pressure piston. By dimensioning the spring force of the said spring it is possible to define the level of pressure in the first pressure chamber, beyond which the first pressure piston couples with the filling piston. According to an embodiment, the stop and the spring are disposed in the first pressure chamber. Alternatively, the spring may be disposed between the filling piston and the first pressure piston and hence serve simultaneously as a restoring spring for the filling piston and the first pressure piston.

If the previously described spring is not disposed between the filling piston and the first pressure piston, then a further spring is preferably provided, which biases the filling piston counter to actuating direction. At the end of an actuation, said spring then presses the filling piston back into its original position.

The first pressure piston and the filling piston may have hydraulically effective areas of equal size. Preferably, however, the hydraulically effective area of the first pressure piston is smaller than the hydraulically effective area of the filling piston in order to avoid too great a drop of the boost factor during the coupling of filling piston and first pressure piston and also in order, in the event of failure of the hydraulic pump, still to provide a pressure intensification which satisfies specific minimum requirements.

Standard modern vehicle brake systems have not only one, but at least two brake circuits so that, in preferred embodiments of the master cylinder arrangement according to the invention, in the bore of the master cylinder a second pressure chamber is delimited, in which is situated a second pressure piston which, upon a displacement in pressure build-up direction, displaces fluid from the second pressure chamber into a second brake circuit.

The hydraulic pump, which is used in the master cylinder arrangement according to the invention and which pumps only the displaced fluid from the filling chamber supplied to it into the first brake circuit and which therefore need not be self-priming, may be a separate pump although it is advantageously the pump of a wheel slip control system, which nowadays is standard equipment in more and more vehicles.

An embodiment of the master cylinder arrangement according to the invention is described in detail below with reference to the accompanying single diagrammatic figure, which shows a longitudinal section.

The figure shows a master cylinder arrangement 10 comprising a master cylinder 12, in the housing 14 of which a bore 16 is formed along an axis A.

In the bore 16 a filling chamber 18 having an outlet 20, a first pressure chamber 22 separate from the filling chamber 18 and having an outlet 24, and a second pressure chamber 26 having an outlet 28 are delimited. In the operable state of the master cylinder 12 the filling chamber 18, the first pressure chamber 22 and the second pressure chamber 26 are completely filled with hydraulic fluid, which passes from a non-illustrated storage container, through connection openings 30, 32 and lines 34, 36 formed in the master cylinder housing 14 into the said chambers 18, 22 and 26.

A filling piston 38 associated with the filling chamber 18 is moreover guided in a sealing and displaceable manner in the bore 16. Connected to the filling piston 38 is a first pressure piston 40, which is associated with the first pressure chamber 22 and is guided in a sealing and displaceable manner in a smaller-diameter portion 42 of the bore 16. In practice, said smaller-diameter portion 42 may also take the form of a guide ring, which is inserted into the bore 16 and effects sealing relative to the bore 16.

The position of the first pressure piston 40 illustrated in the figure is its inoperative or original position, which is defined by a stop 44 in the first pressure chamber 22. A compression spring 46, which is supported by its one end against the smaller-diameter portion 42, presses a ring 48, through which the first pressure piston 40 extends, against the stop 44. The first pressure piston 40 at its free end has an annular collar 50, the outside diameter of which is greater than the diameter of the opening provided in the ring 48.

At its other end facing the filling piston 38 the first pressure piston 40 is provided with a further annular collar 52, which is embraced by a plurality of arms 54, which in the present case are constructed integrally with the filling piston 38. As is evident from the figure, the arms 54 form a guide and a stop for the annular collar 52 so that the first pressure piston 40 is displaceable relative to the filling piston 38 by an amount s along the axis A.

Finally, a second pressure piston 56, which in the present case takes the form of a floating piston and is associated with the second pressure chamber 26, is additionally guided in a sealing and displaceable manner in the bore 16 of the master cylinder 12.

The outlet 20 of the filling chamber 18 is connected by a line 58 in a fluid-conveying manner to the suction side of a hydraulic pump 60. Situated in the line 58 is a valve 62, the purpose of which will be described in greater detail later.

The outlet 24 of the first pressure chamber 22 is in fluid-conveying connection with a first brake circuit 64, with which two wheel brakes 66, 68 are associated. The discharge end of the already mentioned hydraulic pump 60 is likewise connected in a fluid-conveying manner to the first brake circuit 64.

The outlet 28 of the second pressure chamber 26 is in fluid-conveying connection with a second brake circuit 70, with which in the present case two further wheel brakes 72, 74 are associated and in which a further hydraulic pump 60′ is situated. Solenoid valves, which are illustrated in the figure but not described in detail, are associated with all of the wheel brakes 66, 68 and 72, 74, as is customary for wheel-slip-controlled vehicle brake systems and is therefore known to experts in the present field.

The illustrated master cylinder arrangement 10 operates as follows. When an actuating force F is introduced via a non-illustrated brake pedal into the filling piston 38, the latter is displaced to the left and displaces fluid from the filling chamber 18 through the outlet 20 into the line 58 leading to the hydraulic pump 60. The valve 62 in said case is situated in its through position, which is the normal position. Substantially at the same time as the start of the actuation of the master cylinder 12 through introduction of the actuating force F, detectable e.g. by means of the displacement of the filling piston 38, the hydraulic pump 60 starts up and delivers all of the fluid volume displaced from the filling chamber 38 into the first brake circuit 64, in which a correspondingly increased pressure subsequently arises. Said pressure propagates into the first pressure chamber 22, where it acts upon the first pressure piston 40. Because of the ring 48, which is biased towards the stop 44 and against which the first pressure piston 40 is supported by means of its annular collar 50, the first pressure piston 40 initially does not alter its position. At the start of a braking actuation, therefore, the filling piston 38 is displaced relative to the first pressure piston 40, simultaneously reducing the distance s.

In the course of a braking actuation the pressure in the first pressure chamber 22 rises and at some time exceeds the force of the spring 46, which is then compressed so that the first pressure piston 40 moves counter to actuating direction towards the filling piston 38 and hence further reduces the distance s.

If the pressure in the first pressure chamber 40 rises still further the first pressure piston 40—after overcoming the play s—comes into abutment with the filling piston 38 and in the course of the further actuation is pressed by the effective forces against the filling piston 38. After overcoming the distance s, the filling piston 38 is accordingly coupled to the first pressure piston 40 and both pistons 38, 40 in the further course of a brake actuation behave like a single piston.

The pressure prevailing in the first pressure chamber 40 and in the first brake circuit 64 is transmitted via the second pressure piston immediately to the second pressure chamber 26 and the second brake circuit 70 connected thereto. Whereas before a coupling of the filling piston 38 to the first pressure piston 40 the pressure in the brake circuits 64 and 70 is determined only by the pump 60, the pressure prevailing in the brake circuits 64 and 70 after coupling of the two pistons 38 and 40 comprises the pressure fraction delivered by the hydraulic pump 60 and the pressure fraction resulting from the actuating force F introduced via the pistons 38, 40. This means that at the start of a braking actuation the boost factor of the master cylinder arrangement 10 is greater than after coupling of the two pistons 38 and 40. Since at the moment of coupling the pump 60 is already active in a brake boosting manner, the counterforce reacting from said moment on upon the filling piston 38 and hence upon the non-illustrated brake pedal is perceptible only in a reduced form by the driver.

A separation of the filling piston 38 from the first pressure piston 40 occurs during the return motion (return stroke) of the said two pistons, when the annular collar 50 comes into abutment with the ring 48 and so the spring 46 may act upon the first pressure piston 40. A restoring spring, which is not shown here, then presses the filling piston 38 back into its original position and the distance s between the filling piston 38 and the annular collar 52 of the first pressure piston 40 is re-established.

A second hydraulic pump 60′ shown in the figure is used in the usual manner to generate pressure in the second brake circuit 70 during a wheel slip control operation. If desired, however, the hydraulic circuit may alternatively be designed in such a way that it is possible to dispense with the second hydraulic pump 60′; the hydraulic pump 60 then effects the pressure generation in both brake circuits 64 and 70.

In the illustrated and described master cylinder arrangement 10, the brake boosting is achieved by means of the hydraulic pump 60, with the result that the use of a conventional brake booster is superfluous. If the master cylinder arrangement 10 is nevertheless to be operated with a brake booster, which is not shown here, or if the pump 60 is defective, the valve 62 is controlled into its closing position so that a brake pressure may build up also in the filling chamber 38. A check valve 76 in said case allows an overflow of fluid from the filling chamber 38 into the first pressure chamber 22. As a result, there is then no longer any relative displacement between the pistons 38 and 40 because the brake pressure builds up synchronously in all of the chambers 18, 22 and 26.

1. Master cylinder arrangement (10) for a vehicle hydraulic brake system, comprising
a housing (14) and a bore (16), which is formed in said housing along an axis (A) and in which at least one filling chamber (18) and a first pressure chamber (22) are delimited,
a hydraulic pump (60), the discharge end of which delivers pumped fluid into a first brake circuit (64),
a filling piston (38) and, connected thereto, a first pressure piston (40), of which upon a displacement in pressure build-up direction the filling piston (38) displaces fluid from the filling chamber (18) to the suction side of the hydraulic pump (60) and the first pressure piston (40) displaces fluid from the first pressure chamber (22) into the first brake circuit (64), characterized in that
the filling piston (38) and the first pressure piston (40) are movable relative to one another by a limited amount (s) along the axis (A),
the filling piston (38) and the first pressure piston (40) are spring-biased in relation to one another in such a way that they are pushed apart from one another, and that
the filling piston (38) and the first pressure piston (40) couple rigidly to one another after they have been moved towards one another by the amount (s) counter to the spring force pushing them apart from one another.

2. Master cylinder arrangement according to claim 1, characterized in that a stop (44) defines an inoperative position of the first pressure piston (40), and that a spring (46) acting in actuating direction presses the first pressure piston (40) in the direction of said stop (44) as soon as the first pressure piston (40) is displaced out of its inoperative position counter to actuating direction.

3. Master cylinder arrangement according to claim 2, characterized in that the stop (44) and the spring (46) are disposed in the first pressure chamber (22).

4. Master cylinder arrangement according to one of claims 1 to 3, characterized in that a spring biases the filling piston (38) counter to actuating direction.

5. Master cylinder arrangement according to one of the preceding claims, characterized in that the first pressure piston (40) has a smaller hydraulically effective area than the filling piston (38).

6. Master cylinder arrangement according to one of the preceding claims, characterized in that a second pressure chamber (26) is delimited in the bore (16), and that a second pressure piston (56) upon a displacement in pressure build-up direction displaces fluid from the second pressure chamber (26) into a second brake circuit (70).

7. Master cylinder arrangement according to one of the preceding claims, characterized in that the hydraulic pump (60) is the pump of a wheel slip control system.
